(19) United States
(12) Patent Application Publication
(10) Pub. No.: US 2007/0163624 A1
(43) Pub. Date: Jul. 19, 2007

(54) Method for cleaning of articles

(76) Inventors: Kartik Kumar, Maharashtra (IN); Vijay Mukund Naik, Bangalore (IN); Anita Sure, Bangalore (IN); Sambamurthy Jayaraman Suresh, Bangalore (IN); Sumit Taraphdar, Stony Brook, NY (US); Rajanarayana Venkataraghavan, Bangalore (IN); Janhavi Sanjay Raut, Karnataka (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/558,018

(22) PCT Filed: May 13, 2004
(86) PCT No.: PCT/EP04/05188

§ 371 Date: Sep. 25, 2006

(30) Foreign Application Priority Data
May 30, 2003 (IN) 549/MUM/03

(51) Int. Cl. B08B 7/00; C11D 7/32

(52) U.S. Cl. 134/42; 510/438; 510/175

(57) ABSTRACT

A method to clean an article or an object wherein the surface of the article or object to be cleaned (i) is in contact with one or more liquids having a dielectric constant of from 1 to 200, and is (ii) placed in an electric field in the range of 103 V/m to a value limited by the stability of the liquid in the field generated using an alternating voltage/current source.

### TECHNICAL FIELD

The invention relates to a novel method for cleaning of articles or objects, when they are in contact with a liquid, under the application of an electric field, with or without scrubbing, agitation, fluid flow, etc., caused by mechanical or other means.

### BACKGROUND AND PRIOR ART

There is a large volume of information on the methods available for cleaning articles and objects. The method adopted to clean such articles and objects often depends on the nature of soil, the nature of article or object, degree of cleanliness required and the cleaning agents/methods available. The articles and objects most often encountered in every day life are made from materials like wood, ceramic, stone, china clay, glass, natural and synthetic fibers, metals, alloys, modern synthetic polymers and composites thereof, among a host of others. There are also several articles and objects made of similar materials, which are encountered in various industries, which need to be cleaned before they are reused or further processed, or are produced as finished products.

There are several known methods of cleaning articles and objects and these can be broadly classified as:
(i) Mechanical/physical methods like scrubbing, buffing, abrasion, ultasonication;
(ii) Physico-chemical/Chemical methods, such as those involving the use of surfactants, solvents, acids, alkalis, bleaches and enzymes;
(iii) Or a combination of two or more of the above methods.

Every method has its inherent advantages and disadvantages. Mechanical/physical means/methods may give a good surface cleaning but this may not be applicable to systems with inaccessible parts. These methods may also damage or erode the surface. Physicochemical/chemical methods, apart from being expensive, may also damage or corrode the surface of the article or object, and additionally may have an adverse environmental impact after use.

In spite of the large number of methods available for cleaning, there is a constant need to develop better methods to clean, which work faster, are more economical, and have minimal adverse effect on the article or object and the environment.

It has been found by way of the present invention that it is possible to clean articles or objects by placing them in an electric field, in contact with a liquid preferably water which may additionally comprise small amount of surfactant and/or a thickening agent.

JP03082029 (Noriyuki, 1991) discloses a method of removing particulates from the surface of semiconductor devices where the device is held in pure water with application of an alternating current, in the presence of ultrasonic waves.

WO9304790 (Bragger, 1993) discloses a method for cleaning semiconductor wafers comprising the steps of (i) treating purified water with an electrical AC signal of a frequency between 0.1 kHz to 1 GHz to alter the cleaning characteristics of the purified water, (ii) rinsing the semiconductor wafer with the treated, purified water to remove contaminants.

JP06232103 (Sadahiro et al. 1994) discloses a method of cleaning semiconductor devices with a combination of electrostatic and ultrasonic washing. Here, the semiconductor wafer is immersed in a solution preferably of an electrolyte in water and an alternating field is applied across the wafer to remove static electricity from the wafer to be washed. The particles are simultaneously dislocated using an ultrasonicator.

The above methods are specifically applicable for cleaning of semiconductor devices especially suited for removal of micron size particulate soil. The above cited prior art publications also use a combination of methods to achieve the desired result. There is yet a need for developing a more efficient method for removal of soils from larger number of commonly used articles and objects, more effectively and in very short time.

### OBJECTS OF THE INVENTION

It is thus an object of the present invention to remove soils and deposits from a large number of common articles or objects made of metals, polymers/plastics, natural as well as synthetic fibers, glass, ceramics, wood, stone and the like; and the alloys/composites/wovens/non-wovens/layers and combinations there of.

It is a further object of the present invention to remove soils and deposits of various types like carbon soot, dust, mud, sebum, oils and fats, foods, beverages, burnt residues, grease, microbial plant/animal cells, cell fragments, synthetic/natural chemicals, and others, and combinations there of, irrespective of their physical and chemical nature, from commonly used articles or objects.

It is another object of the present invention to remove soils and deposits from articles or objects without or with only a minimal amount of a chemical cleaning agent e.g. surfactant, being used.

It is another object of the present invention to remove soils and deposits from articles or objects without or with only a minimal amount of a chemical cleaning agent, in an economical and efficient manner.

It is another object of the present invention to remove soils and deposits from articles or objects without or with only a minimal amount of a chemical cleaning agent, in an inexpensive and safe manner in much shorter time.

A further object of the present invention is to remove soils and deposits from articles or objects without or with only a minimal amount of a chemical cleaning agent in an inexpensive and safe manner in much shorter time without any substantial change to the characteristics of the article or object.

Another object of the present invention is to remove soils and deposits from articles or objects without or with only a minimal amount of a chemical cleaning agent in an inexpensive and safe manner in much shorter time without any substantial change to the characteristics of the article or object and by minimizing the generation of environmentally unsafe effluents during the cleaning process.

### SUMMARY OF THE INVENTION

The invention provides for a method to clean an article or an object wherein the surface of the article or object to be cleaned
(i) is in contact with one or more liquids having a dielectric constant of from 1 to 200.
   and is
(ii) placed in an electric field in the range of 10³ V/m to a value limited by the stability of the liquid in that field, generated using an alternating voltage/current source.

For the purposes of this invention, the word “liquid” refers to all media in the liquid state including liquids whose consistency has been modified by the use of thickening agent and comprises media in the solution, emulsion and gel states.

It is particularly preferred that the surface of the article or object to be cleaned is in contact with water.

A preferred aspect of the invention provides for a method to clean an article or object wherein the surface of the article or object to be cleaned:
(i) is in contact with an aqueous solution containing a chemical chosen from non-ionic, amphoteric or zwitterionic surfactant types, or mixtures there of, wherein the total concentration of the surfactants in water is such that the aqueous solution has a surface tension of less than 50 mN/m
   and is
(ii) placed in an electric field in the range of 10³ V/m to 10⁷ V/m generated using an alternating voltage/current source.

It is highly preferred that the electric field is in the range of 2.5×10³ V/m to 4×10⁵ V/m generated using an alternating voltage/current source.

It is particularly preferred that the aqueous solution of surfactant has a surface tension from 15 to 50 mN/m.

Another aspect of the invention provides for a method to clean an article or an object wherein the surface of the article or object to be cleaned
(i) is in contact with an aqueous gel medium
   and is
(ii) placed in an electric field in the range of 10³ V/m to a value limited by the stability of the liquid in that field, generated using an alternating voltage/current source.

### DETAILED DESCRIPTION OF THE INVENTION

The first aspect of the invention provides for a method to clean an article or object by contacting the surface of the said article/object with one or more liquids having a dielectric constant of from 1 to 200 and placing it in an electric field in the range of 10³ V/m to a value limited by the stability of the liquid in that field, generated using an alternating voltage/current source.

Liquids:

For the purposes of this invention, the word “liquid” refers to all media in the liquid state including liquids whose consistency has been modified by the use of thickening agent and includes media in the solution, emulsion and gel states.

Any liquid having a dielectric constant in the range of 1 to 200 can be used. Suitable solvents that can be used include water and organic solvents including compounds of the class of alkanes, aliphatic and aromatic alcohols, primary and secondary amides and mixtures thereof. Liquids having a dielectric constant in the range of 1 to 100 are particularly preferred.

It is particularly preferred that the liquid used is water. It is also preferred that any other liquid may be used mixed with water such that the dielectric constant of the media is in the range of 1 to 200.

Although, it is not essential as per the method of the present invention that the liquid used is in motion, it is possible that the liquid could be flowing at a suitable flow rate, and could be replenished or recirculated. The method as per the invention can also be carried out in combination with any other known method of cleaning e.g mechanical methods like agitation, scrubbing, ultrasonication, etc, although this is not-an essential feature of the invention.

Articles or Objects to be Cleaned:

The article or object to be cleaned can be made of any solid material whose surface is hard or soft or porous, and can be a good or a poor conductor of electricity or a dielectric. Preferred articles or objects that can be cleaned by the method of the present invention include those made of metals, polymers/plastics, natural as well as synthetic fibers, glass, ceramics, wood, stone and the like; and the alloys/composites/wovens/non-wovens/layers and combinations there of. It is also possible that the article or object to be cleaned is used as one of the electrodes.

Concentration and Type of Surfactants

It is preferred that the article or object to be cleaned is in contact with a dilute aqueous solution of surfactants, and the said article or object is placed in an electric field in the range of 10³ V/m to 10⁷ V/m, generated using an altematng voltage/current source. It is preferred that the concentration of the surfactant in water is such that the surface tension of the surfactant solution is in the range of 15-5 mN/m. The invention can also be worked at higher surfactant concentrations.

Examples of zwitterionic or amphoteric or nonionic or anionic or cationic surfactant species that fall within the scope of the present invention are given in the following well-known textbooks: (i) “Surface Active Agents”, Volume I by A. M. Schwartz and J. W. Perry, (ii) “Surface Active Agents and Detergents”, Volume II by A. M. Schwartz, J. W. Perry and J. Berch, (iii) “Handbook of Surfactants” by M. R. Porter, (iv) “Amphoteric Surfactants” by E. G. Lomax.

Although any surfactant may be used, it is preferred that the surfactant used is of the non-ionic, amphoteric or zwitterionic type. Suitable nonionic surfactants can be broadly described as compounds produced by the condensation of alkylene oxide groups, which are hydrophilic in nature, with an organic hydrophobic compound which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements.

Particular non-limiting examples include the condensation products of aliphatic alcohols having from 6 to 22 carbon atoms in either straight or branched chain configuration with ethylene oxide, such as a coconut oil ethylene oxide condensate having from 2 to 15 moles of ethylene oxide per mole of coconut alcohol; condensates of alkylphenols whose alkyl group contains from 6 to 22 carbon atoms with 2 to 15 moles of ethylene oxide per mole of alkyphenol; condensates of the reaction product of ethylenediamine and propylene oxide with ethylene oxide, the condensate containing from 40 to 80% of polyoxyethylene radicals by weight; tertiary amine oxides of structure R₃NO, where one group R is an alkyl group of 6 to 22 carbon atoms and the others are each methyl, ethyl or hydroxyethyl groups, for instance dimethyldodecylamine oxide; tertiary phosphine oxides of structure R₃PO, where one group R is an alky group of from 6 to 22 carbon atoms, and the others are each alkyl or hydroxyalky groups of 1 to 3 carbon atoms, for instance dimethyldodecylphosphine oxide; and dialkyl sulphoxides of structure R₂SO where the group R is an alkyl group of from 6 to 22 carbon atoms and the other is methyl or ethyl, for instance methyltetradecyl sulphoxide; fatty add alkylolamides; alkylene oxide condensates of fatty acid alkylolamides and alky mercaptans.

The word “amphoteric surfactant” is used to describe surface active molecules for which the ionic character of the polar group depends on the solution pH. The word “zwitterionic surfactants” is used to describe surface active molecules that contain both positively and negatively charged groups.

Suitable amphoteric and zwitterionic surfactant compounds that can be employed are those containing quatemary ammonium, sulfonium, oxonium or phosphonium ions as cations, and carboxylate, sulfonate, sulfate, sulfite, phosphinate, phosphonite, phosphito or phosphate groups as anions.

Particular non-limiting examples of zwitterionic or amphoteric surfactants include alkyl amino acids, alkyl betaines, alkyl iminiodiacids, alkyl imidazoline derived amphoterics, alkyl poly amino carboxylates, alkyl ammonio dimethyl propyl sufonates, phosphatidylcholines, sulfonium betaines, phosphonium betaines, sulfobetaines, sufitobetaines, sulfatobetaines, phophinate betaines, phosphonate betaines, phosphitobetaines, phosphatobetaines and alkyl ammonio sulfonates.

The invention provides for a method to clean surface of articles or objects when they are in contact with a liquid with specific properties and is placed in an electric field. It is also possible that the liquid is formulated as a solution, an emulsion, or a gel or any other physical form. When the liquid is formulated, it is particularly preferred that the liquid is present as a gel. This may be achieved by adding suitable thickening agents to the liquids. Suitable thickening agents include natural polysaccharides like starch, modified starch, modified celluloses and natural gums and synthetic polymers including polyvinyl alcohol, polyacrylates and poyacrylamides.

Alternating Electric Field:

The article/object to be cleaned is placed in an electric field generated using an alternating voltage/current source. The article is preferably placed between two electrodes, and is subject to an alternating field by connecting a source of alternating voltage/current across the electrodes.

The electric field between the electrodes is determined by dividing the measured voltage drop across the electrodes by the distance between the electrodes, and is suitably represented as V/m. Thus, the electric field strength depends both on the voltage applied as well as the distance between the electrodes. The suitable range of electric field for the purpose of the present invention is 10³ V/m to a value limited by the stability of the liquid in that field. The preferred range of the electric field is in the range of 10³ V/m to 10⁷ V/m. Particularly preferred range of electric field is in the range of 2.5×10³ V/m to 4×10⁵ V/m.

The term alternating means periodic or non-periodic time variance and time reversal of the corresponding parameter. If the alternating voltage/current source gives periodic variation, the resultant voltage/current wave-form could be of any shape, such as sinusoidal, triangular, square or pulsed, or combinations thereof.

The electrodes can be made from any conducting material, like stainless steel, copper, aluminum, conducting polymers, etc. The conducting electrodes may also be prepared by coating a conducting material on other semiconducting/dielectric/leaky dielectric materials. The conducting electrodes may also be coated, painted or inked with other conducting/semiconducting/dielectric/leaky dielectric materials, such as polyester, PVC, barium titanate, vanadium pentoxide, glass and polytetrafluoroethylene. The shape and size of the electrodes are designed based on the application. It is also possible that the article or object to be cleaned is used as one of the electrodes.

The invention shall now be demonstrated with reference to the following non-limiting examples.

### EXAMPLES

Two types of articles/objects to be cleaned were used for this purpose: (i) Non-porous objects (Glass and stainless steel plates), (ii) Porous objects (fabric swatches).

In the case of the object being a glass/SS plate, the following procedure was adopted. A thin layer of soil was applied on the object. The soiled object was placed between two parallel stainless steel electrodes, held about 0.5 to 2 cm apart, across which a suitable AC voltage was applied. The object and the electrodes were completely immersed in a cuvette containing the wash medium. The electric field was switched on to initiate the cleaning.

In the case of the object being a fabric swatch, the following procedure was adopted. A pre-soiled fabric swatch, procured from the wfk-Cleaning Technology Research Institute, Campus Fichtenhain 11-D-47807 Krefeld, Germany, was taken. The fabric, referred to as WFK20D by the supplier, is a blend of polyester (synthetic) and cotton (natural) fibers, and contains composite soil. The reflectance of the fabric was measured at 460 nm wavelength excluding UV component. The fabric swatch was then placed between two parallel stainless steel electrodes, held about 0.5 to 2 cm apart, across which a suitable AC voltage was applied. The object and the electrodes were completely immersed in a cuvette containing wash medium. The electric field switched on to initiate the cleaning. The reflectance of the fabric at 460 nm wavelength was again measured. The increase in the reflectance (ΔR*) of the fabric over that measured before the cleaning process, which was taken to be an indirect measure of the cleanliness of the fabric, was noted down.

The details of the experiments conducted with various objects and soils, along with the results are provided in table 1. Table 1 also indicates the results with the improvement in cleaning (either in terms of change in degree of cleaning or the time taken) with and without the application of the electric field.

TABLE 1

| | | | | | | | Surface | | | |
|---|---|---|---|---|---|---|---|---|---|---|
| | | | | | | | tension of | | | |
| | | | Surfactant | Electric | | Object | surfactant | | Time for | |
| | Wash | Dielectric | used, | Field | | To be | solution | | Cleaning | |
| Experiment | Medium | Constant | concentration | (V/m) | Soil | cleaned | (mN/m) | | (seconds) | Result |
| 1.1a | Water | 80 | (i), 100 ppm | 0 | Mustard oil | SS Plate | 38 | mN/m | 60 | 32% Oil |
| | | | | | | | | | | Removed |
| 1.1b | Water | 80 | (i), 100 ppm | 25000 | Mustard oil | SS Plate | 38 | mN/m | 60 | 100% Oil |
| | | | | | | | | | | Removed |
| 1.2a | Water | 80 | (i), 100 ppm | 0 | Mustard oil | Glass Plate | 38 | mN/m | 60 | 40% Oil |
| | | | | | | | | | | Removed |
| 1.2b | Water | 80 | (i), 100 ppm | 665000 | Mustard oil | Glass Plate | 38 | mN/m | 60 | 100% Oil |
| | | | | | | | | | | Removed |
| 1.3a | Water | 80 | (i), 500 ppm | 0 | Composite | Polyester- | 38 | mN/m | 60 | Fabric not |
| | | | | | Soil | Cotton | | | | cleaned |
| | | | | | (WFK20D) | Fabric | | | | ΔR* = 2.1 |
| | | | | | | (WFK20D) | | | | (Average of 2 |
| | | | | | | | | | | swatches) |
| 1.3b | Water | 80 | (i), 500 ppm | 200000 | Composite | Polyester- | 38 | mN/m | 60 | Fabric cleaned |
| | | | | | Soil | Cotton | | | | ΔR* = 10.7 |
| | | | | | (WFK20D) | Fabric | | | | (Average of 3 |
| | | | | | | (WFK20D) | | | | swatches) |
| 1.4a | Water | 80 | (iv), 0 ppm | 0 | Carbon | SS Plate | 71 | mN/m, | ˜60 | No removal of |
| | | | | | soot | | | | | Soot |
| 1.4b | Water | 80 | (iv), 0 ppm | 40000 | Carbon | SS Plate | 71 | mN/m, | ˜60 | 96% of soot |
| | | | | | soot | | | | | removed |
| 2.1a | Water | 80 | (i), 100 ppm | 0 | Mustard oil | SS Plate | 32 | mN/m | >1800 | Incompletely |
| | | | | | | | | | | cleaned |
| 2.1b | Water | 80 | (i), 100 ppm | 404000 | Mustard oil | SS Plate | 32 | mN/m | 2 | Completely |
| | | | | | | | | | | cleaned |
| 2.2a | Water | 80 | (ii), 5000 ppm | 0 | Mustard oil | SS Plate | 32 | mN/m | ˜1800 | No cleaning |
| 2.2b | Water | 80 | (ii), 5000 ppm | 25000 | Mustard oil | SS Plate | 32 | mN/m | ˜30 | Cleans, |
| | | | | | | | | | | accompanied by |
| | | | | | | | | | | electrolysis |
| 2.3a | Water | 80 | (iii), 935 ppm | 0 | Mustard oil | SS Plate | 38 | mN/m | ˜1800 | No cleaning |
| 2.3b | Water | 80 | (iii), 935 ppm | 75000 | Mustard oil | SS Plate | 38 | mN/m | ˜30 | Cleans, |
| | | | | | | | | | | accompanied by |
| | | | | | | | | | | electrolysis |
| 3.1a | Decane | 1.98 | (iv), 0 ppm | 0 | Mustard oil | SS Plate | 23.37 | mN/m, | 1200 | Completely |
| | | | | | | | | | | cleaned |
| 3.1b | Decane | 1.98 | (iv), 0 ppm | 500000 | Mustard oil | SS Plate | 23.37 | mN/m, | 60 | Completely |
| | | | | | | | | | | cleaned |
| 3.2a | Butyl | 5.52 | (iv), 0 ppm | 0 | Mustard oil | SS Plate | 32.03 | mN/m, | 90 | Completely |
| | benzoate | | | | | | | | | cleaned |
| 3.2b | Butyl | 5.52 | (iv), 0 ppm | 666666.7 | Mustard oil | SS Plate | 32.03 | mN/m, | 10 | Completely |
| | benzoate | | | | | | | | | cleaned |
| 3.3a | Hexanol | 13.03 | (iv), 0 ppm | 0 | Mustard oil | SS Plate | 25.81 | mN/m, | >1800 | Incompletely |
| | | | | | | | | | | cleaned |
| 3.3b | Hexanol | 13.03 | (iv), 0 ppm | 86666.7 | Mustard oil | SS Plate | 25.81 | mN/m, | 180 | Completely |
| | | | | | | | | | | cleaned |
| 3.4a | Butanol | 17.84 | (iv), 0 ppm | 0 | Mustard oil | SS Plate | 24.93 | mN/m, | >1800 | Incompletely |
| | | | | | | | | | | cleaned |
| 3.4b | Butanol | 17.84 | (iv), 0 ppm | 86666.7 | Mustard oil | SS Plate | 24.93 | mN/m, | 60 | Completely |
| | | | | | | | | | | cleaned |
| 3.5a | Propanol | 20.8 | (iv), 0 ppm | 0 | Mustard oil | SS Plate | 23.32 | mN/m, | >1800 | Incompletely |
| | | | | | | | | | | cleaned |
| 3.5b | Propanol | 20.8 | (iv), 0 ppm | 86666.7 | Mustard oil | SS Plate | 23.32 | mN/m, | 120 | Completely |
| | | | | | | | | | | cleaned |
| 3.6a | Ethanol | 25.3 | (iv), 0 ppm | 0 | Mustard oil | SS Plate | 21.97 | mN/m, | >1800 | Incompletely |
| | | | | | | | | | | cleaned |
| 3.6b | Ethanol | 25.3 | (iv), 0 ppm | 130000 | Mustard oil | SS Plate | 21.97 | mN/m, | 420 | Completely |
| | | | | | | | | | | cleaned |
| 3.7a | Methanol | 33 | (iv), 0 ppm | 0 | Mustard oil | SS Plate | 22.07 | mN/m, | >1800 | Incompletely |
| | | | | | | | | | | cleaned |
| 3.7b | Methanol | 33 | (iv), 0 ppm | 65000 | Mustard oil | SS Plate | 22.07 | mN/m, | 1 | Oil film ruptures, |
| | | | | | | | | | | Partially Cleans. |
| 3.8a | Water | 80 | (iv), 0 ppm | 0 | Mustard oil | SS Plate | 72 | mN/m, | >1800 | Incompletely |
| | | | | | | | | | | cleaned |
| 3.8b | Water | 80 | (iv), 0 ppm | 104000 | Mustard oil | SS Plate | 72 | mN/m, | 1 | Oil film ruptures, |
| | | | | | | | | | | Partially Cleans. |
| 3.9a | Formamide | 111 | (iv), 0 ppm | 0 | Mustard oil | SS Plate | 57.03 | mN/m, | >1800 | Incompletely |
| | | | | | | | | | | cleaned |
| 3.9b | Formamide | 111 | (iv), 0 ppm | 26000 | Mustard oil | SS Plate | 57.03 | mN/m, | 1 | Oil film ruptures, |
| | | | | | | | | | | Partially Cleans. |
| 3.10a | n-Methy | 189 | (iv), 0 ppm | 0 | Mustard oil | SS Plate | 40.47 | mN/m, | >1800 | Incompletely |
| | Formamide | | | | | | | | | cleaned |
| 3.10b | n-Methy | 189 | (iv), 0 ppm | 26000 | Mustard oil | SS Plate | 40.47 | mN/m, | 1 | Oil film ruptures, |
| | Formamide | | | | | | | | | Partially Cleans. |
| 3.11a | 10% | | (i), 1800 ppm | 0 | Mustard oil | SS Plate | | | >1800 | Incompletely |
| | Ethanol in | | | | | | | | | cleaned |
| | Water | | | | | | | | | |
| 3.11b | 10% | | (i), 1800 ppm | 106000 | Mustard oil | SS Plate | | | 30 | Completely |
| | Ethanol in | | | | | | | | | cleaned |
| | Water | | | | | | | | | |
| 4.1a | Ethanol | 25.3 | (i), 5000 ppm | 0 | Mustard oil | SS Plate | | | >1800 | Incompletely |
| | | | | | | | | | | cleaned |
| 4.1b | Ethanol | 25.3 | (i), 5000 ppm | 150000 | Mustard oil | SS Plate | | | 180 | Completely |
| | | | | | | | | | | cleaned |
| 5.1a | Water + | 80 | (i), 3000 ppm | 0 | Composite | Polyester | | | 180 | Fabric cleaned |
| | Gelrite | | | | soil | cotton fabric | | | | ΔR* = 10.9 |
| | Gellan gum | | | | (WFK20D) | (WFK20D) | | | | (average of 3 |
| | | | | | | | | | | swatches) |
| 5.1b | Water + | 80 | (i), 3000 ppm | 20000 | Composite | Polyester | | | 180 | Fabric cleaned |
| | Gelrite | | | | soil | cotton fabric | | | | ΔR* = 20.3 |
| | Gellan gum | | | | (WFK20D) | (WFK20D | | | | (average of 3 |
| | | | | | | | | | | swatches) |
| 5.2a | Water + | 80 | (i), 3000 ppm | 0 | Composite | Polyester | | | 180 | Fabric cleaned |
| | Phytagel | | | | soil | cotton fabric | | | | ΔR* = 10.5 |
| | | | | | (WFK20D) | (WFK20D | | | | (average of 3 |
| | | | | | | | | | | swatches) |
| 5.2b | Water + | 80 | (i), 3000 ppm | 20000 | Composite | Polyester | | | 180 | Fabric cleaned |
| | Phytagel | | | | soil | cotton fabric | | | | ΔR* = 20.5 |
| | | | | | (WFK20D) | (WFK20D | | | | (average of 3 |
| | | | | | | | | | | swatches) |

Legend:
(i) represents zwitterionic surfactant, 3-(N,N-Dimethylpalmitylammonio)-propansulphonate (C₂₁H₄₅NO₃S), was used.
(ii) represents anionic surfactant: Sodium dodecyl sulphate (C₁₂H₂₅NaSO₄), was used.
(iii) represents cationic surfactant: N Cetyl-N,N,N-trimethyl ammonium bromide (C₁₉H₄₂BrN), was used.
(iv) represents that no surfactant was used.
(v) Experimental set indices a and b have been used to differentiate experiments in the absence and presence of electric field respectively.
(vi) Data on dielectric constant and surface tensions of wash media except 15, 16, 30, 31, extracted from CRC Handbook of Chemistry and Physics, 80^{th} Edition.
(vii) Data on dielectric constant and surface tensions of wash media 15, 16, 30 and 31 determined through experiments.

The results in Table 1 indicate that the method of cleaning as per the invention (example numbers with extension b) is effective over a wide range of electric fields and for several different types of objects containing different types of deposits/soils when in contact with a variety of liquids as compared to methods of the prior art (example numbers with extension a).

1. A method of cleaning an article or an object wherein the surface of the article or object to be cleaned is
(i) in contact with one or more organic solvents having a dielectric constant of from 1 to 200; and
(ii) placed in an electric field in the range of 10³ V/m to a value limited by the stability of the one or more organic solvents in the field generated using an alternating voltage/current source.

2. A method of cleaning as claimed in claim 1 wherein the dielectric contstant of the one or more solvents is in the range of 1 to 100.

3. A method of cleaning as claimed in claim 1 wherein the organic solvent is selected from alkanes, aliphatic alcohols, aromatic alcohols, primary amides, secondary amides, and mixtures thereof.

4. A method of cleaning an article or an object wherein the surface of the article or object to be cleaned is
(i) in contact with an aqueous surfactant solution having a dielectric constant of from 1 to 200 wherein the total concentration of the surfactants in water is such that the aqueous solution has a surface tension of less than 50 mN; and
(ii) placed in an electric field in the range of 10³ V/m to a value limited by the stability of the aqueous surfactant solution in the field generated using an alternating voltage/current source.

5. A method of cleaning as claimed in claim 4 wherein the surfactant is chosen from non-ionic, amphoteric or zwitterionic surfactant types, or mixtures thereof.

6. A method of cleaning as claimed in claim 4 wherein the aqueous solution has a surface tension in the range of 15 to 50 mN.

7. A method of cleaning as claimed in claim 1 wherein the electric field is in the range of 10³ V/m to 10⁷ V/m.

8. A method of cleaning as claimed in claim 7 wherein the electric field is in the range of 2.5×10³ V/m to 4×10⁵ V/m.

9. A method of cleaning as claimed in claim 1 wherein the method additionally comprises other known cleaning method including agitation, scrubbing, or ultrasonication.

10. A method of cleaning as claimed in claim 1 wherein the substrate to be cleaned is chosen from metals, polymers, plastics, natural or synthetic fibers, glass, ceramics, wood, stone and combinations thereof including alloys, composites, wovens, non-wovens and layers thereof.
